(19) United States
(12) Patent Application Publication
(10) Pub. No.: US 2005/0007498 A1
(43) Pub. Date: Jan. 13, 2005

(54) Tuner for reception of digital and analog television signals

(75) Inventors: Glenn W. Eswein, Branchburg, NJ (US); Mats Lindstrom, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: Conexant Systems, Inc.

(21) Appl. No.: 10/353,538

(22) Filed: Jan. 28, 2003

(51) Int. Cl. H04N 5/50

(52) U.S. Cl. 348/731

(57) ABSTRACT

A television tuner for tuning analog and digital television signals that requires only one off-chip filter. An integrated first frequency stage up-converts the received signal to a higher frequency. An off-chip filter provides coarse tuning of the up-converted signal. An integrated second frequency stage separates and down-converts the signal into I and Q components having a low IF in a range of 10-15 MHz. An integrated on-chip filter finely tunes the I and Q components. Where tuning of both analog and digital signals is contemplated, the on-chip filter is an image rejection filter. Where tuning of only digital signals is contemplated, the on-chip filter may be a DC notch filter.

### FIELD OF THE INVENTION

The present invention relates to television tuners and more particularly relates to a tuner capable of receiving both digital and analog television signals and requiring only one off-chip IF filter.

### BACKGROUND OF THE INVENTION

With the advent of digital television, and the continued role of analog television, there is a need for integrated television receivers that can receive and process both digitally modulated television signals, such as digital terrestrial broadcast television signals modulated in accordance with the 8VSB and/or COFDM modulation schemes, as well as those that have analog modulation, such as NTSC and PAL broadcast television signals. Traditional tuner architectures capable of processing both digital and analog signals require multiple external filters to achieve the interfering channel rejection that is required for acceptable reception. Since external filters add cost to any complete receiver solution, it is desirable to reduce the number of external filters that are required.

Traditional tuners for analog television reception have low levels of integration. Traditional analog tuners typically require multiple front-end preselector filters, separately-packaged IF (intermediate frequency) SAW (surface acoustical wave) filters and separately-packaged audio filters. A traditional analog television tuner can be modified for digital television reception by adding another IF SAW filter, although the audio filters can be eliminated. Hence, for a traditionally configured tuner to receive both analog and digital television signals, multiple preselector filters, one or two audio filters and two IF SAW filters are used. The IF SAW filters are not integrated on the tuner IC but rather are implemented off-chip.

Recent tuner architectures have proposed eliminating the need for multiple discrete front-end preselector filters by adding a highly linear up-converter and a separately packaged, high frequency first IF external filter. In order for these new architectures to accomodate both analog and digital television signals, however, a second IF SAW filter (that must be implemented off-chip) and audio filters as used by traditional tuners are still required.

### SUMMARY OF THE INVENTION

The present invention provides an integrated tuner that eliminates the need for all but one external filter and can be used to receive both digital and analog television is provided. A received signal is converted to a second IF frequency that is about ½ to ⅓ of the second IF frequency of traditional and recently promoted tuners. At this lower frequency, it is possible to produce integrated filters that can handle the required interfering channel rejection. These integrated filers and the external first IF filter, in conjunction with a high performance analog-to-digital converter in a demodulator/decoder component that can process both digital and analog signals, provide all adjacent-channel, image and other interfering channel rejection necessary for superb digital and analog television reception.

One embodiment of the invention is a television tuner. The tuner includes a tuner IC having a first frequency conversion stage that up-converts the frequency of a received television signal; an output to an off-chip filter; an input from the off-chip filter; a second frequency conversion stage that separates and down-converts the television signal into low IF I and Q components; and an integrated, on-chip filter for fine-tuning the down-converted low IF I and Q components. The on-chip filter is an image rejection filter in one implementation and a DC notch filter in another implementation. The tuner also includes a non-integrated off-chip filter that provides coarse tuning of the up-converted television signal between the first and second frequency conversion stages.

Another embodiment of the invention is a tuner IC. A first frequency conversion stage up-converts the frequency of a received television signal. Outputs and inputs are provided for off-chip filtering after the first frequency conversion stage. A second frequency conversion stage separates and down-converts the signal into low IF I and Q components. An on-chip filter fine tunes the down-converted I and Q components.

Another embodiment of the invention is a television tuner. Integrated up-conversion means up-converting the frequency of a received television signal. Non-integrated filtering means coarse tune the received television signal. Integrated down-conversion means down-convert the up-converted signal into low IF I and Q components. Integrated filtering means fine tune the low IF I and Q components.

Another embodiment of the invention is a method for tuning a television signal. A television signal is received and up-converted to a higher frequency. Off-chip filtering is performed on the higher frequency signal. The higher frequency signal is then down-converted into low IF I and Q components, and on-chip filtering is performed on the down-converted I and Q components.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a schematic diagram illustrating a conventional television receiver tuner.

FIG. 2 is a schematic diagram illustrating one embodiment of a television receiver tuner according to the present invention.

FIG. 3 is a schematic diagram illustrating another embodiment of a television receiver tuner according to the present invention.

FIG. 4 is a flow chart illustrating a method for tuning a television signal according to the present invention.

### DETAILED DESCRIPTION

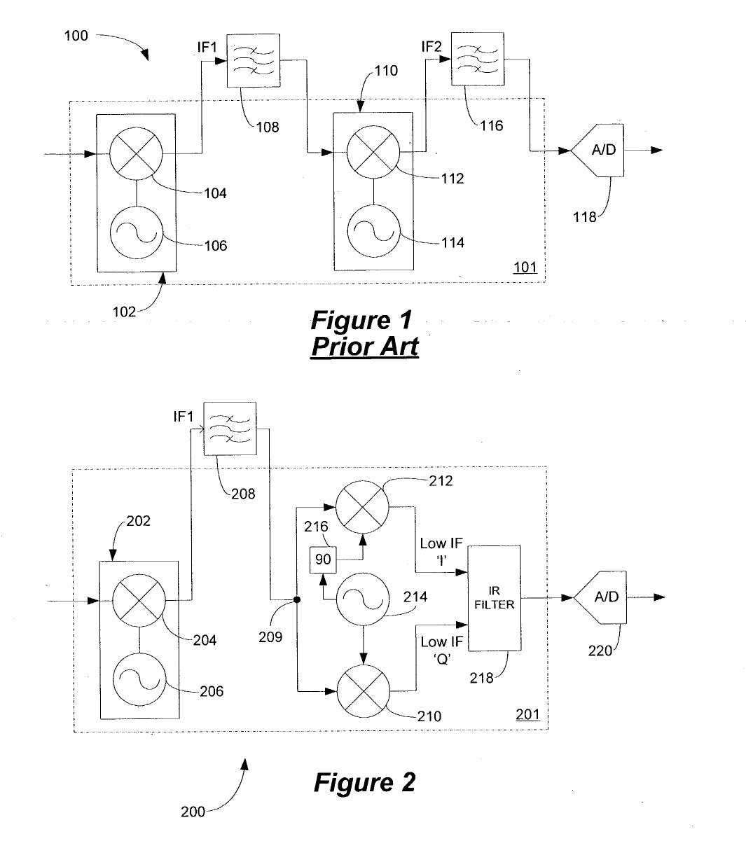

FIG. 1 is a schematic diagram illustrating a conventional television receiver tuner 100 for reception of digital and/or analog broadcast television signals. Tuner 100 receives input analog and/or digital RF signals from a cable line, antenna or other broadcast or cable RF signal source. It may be incorporated in a digital or analog terrestrial television, set top box, cable modem, RF tuner or other receiving system. For cable television broadcasts, for example, the RF signals received by tuner 100 will be in a range of approximately 50-850 MHz.

A first frequency conversion stage 102, comprising mixer 104 and local oscillator 106, mixes the received signal with a signal from local oscillator 106 to generate a signal at a first intermediate frequency (IF1). Mixer 104 is typically an up-conversion mixer and, hence, the frequency of signal IF1 output by first frequency conversion stage 102 is typically higher than the frequency of the received RF signal. In one embodiment, IF1 is approximately 1220 MHz. In this configuration, first frequency conversion stage 102 may be referred to as frequency upconverter 102.

Signal IF1 is coupled to first IF filter 108. IF filter 108 is typically a SAW filter that provides coarse channel selection and, as can be seen in FIG. 1, is an external filter that must be implemented off-chip. IF filter 108 must be implemented off-chip because, with high IF1 frequencies that may approach 1220 MHz, a very high degree of selectivity is required. This high degree of selectivity that is required precludes integration of the filter on-chip. The channel selection provided by IF filter 108 is typically a band of channels but may be even a single channel.

The output of first IF filter 108 is provided to second frequency conversion stage 110, comprising second mixer 112 and second local oscillator 114. Mixer 112 mixes signal IF1 with a signal from second local oscillator 114 to generate a signal at a second intermediate frequency (IF2). Mixer 112 is typically a down-conversion mixer and, hence, the frequency of signal IF2 output by second frequency conversion stage 110 is typically lower than the frequency of input signal IF1. In this configuration, second frequency conversion stage 110 may be referred to as frequency downconverter 110.

In conventional tuners IF2 is still a relatively high frequency, typically in the range of 44 MHz. Signal IF2 is coupled to a second IF filter 116. Second IF filter 116 is typically another external SAW filter that is implemented off-chip. The relatively high IF2 frequency used by conventional tuners again requires a filter with a high degree of selectivity that, consequently, must be implemented off-chip rather than integrated. The output of second IF filter 116 is subjected to further processing and/or filter in a known manner, including processing by a high performance analog-to-digital converter 118, to provide digital and analog television reception.

As can be seen in FIG. 1, both IF filters 108 and 116 are implemented off the tuner IC 101. Multiple external filters increase the cost and size of the total receiver solution, make implementation more difficult since more inputs and outputs are required, and increase the complexity of the circuit board layout task.

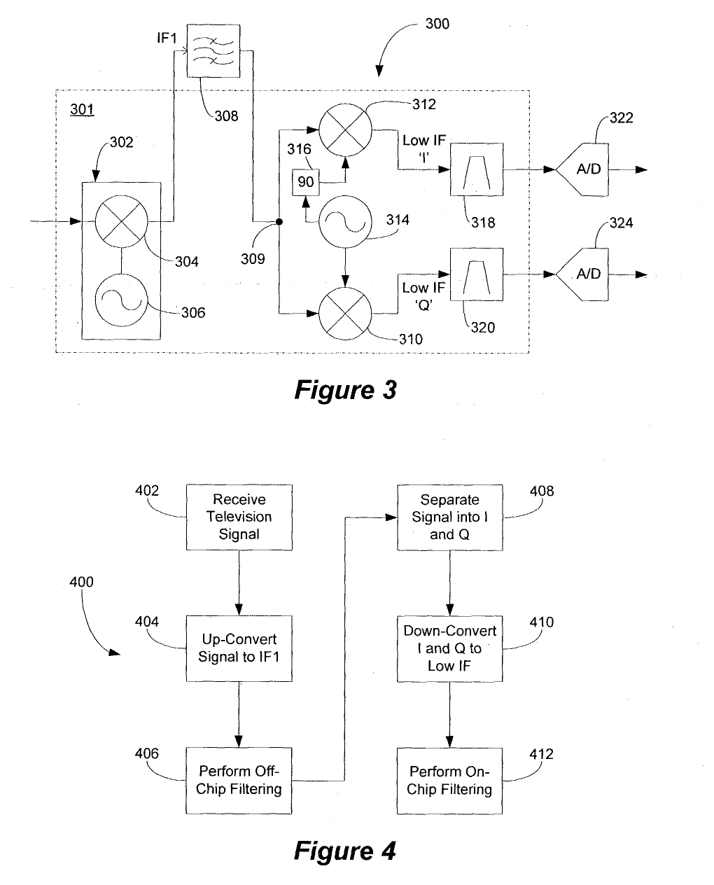

It should be noted that only those components necessary to compare and contrast tuner 100 with the inventive tuner of the present invention (illustrated in FIGS. 2 and 3) have been illustrated. Tuner 100 and others like it will typically include additional components that are not relevant to the present invention but are well known to those of ordinary skill in the art. For instance, a low noise amplifier may precede the first frequency conversion stage in order to amplify the received RF signal a fixed amount with minimal noise amplification. An RF attenuator may also be employed to set signal gain based on the strength of the received signal. An IF AGC amplifier may follow second IF filter 116 to further control the overall tuner gain. These and other components of television tuners are well known to those of ordinary skill in the art and further explanation and/or illustration is not necessary for an understanding of the present invention.

FIG. 2 depicts a first embodiment of the present invention. Tuner 200 is advantageous in that all components, with the exception of one external IF filter, are integrated on-chip. A first external IF filter is retained, but the need for a second IF filter, such as IF filter 116 in tuner 100, is eliminated. Consequently, the television receiver is smaller, cheaper and easier to implement than receivers that use a traditional tuner (such as tuner 100). It is smaller and cheaper, since the size and cost of a relatively large external filter package has been eliminated. It is easier to implement, since a tuner circuit chip with integrated filters requires less inputs and outputs, which reduces the number of required discrete components and makes the circuit board layout task faster and less complex.

Tuner 200 includes first frequency conversion stage 202, comprising mixer 204 and local oscillator 206, which mixes the received signal with a signal from local oscillator 206 to generate a signal at a first intermediate frequency (IF1). Mixer 204 is typically an up-conversion mixer and, hence, the frequency of signal IF1 output by first frequency conversion stage 202 is typically higher than the original frequency of the received signal. In this configuration, first frequency conversion stage 202 may be referred to as frequency upconverter 202.

Signal IF1 is coupled to first IF filter 208. IF filter 208 is typically a SAW filter that provides coarse channel selection and. As in conventional tuners, IF1 is a relatively high frequency and, consequently, filter 208 requires a high degree of selectivity and must be implemented off-chip. The channel selection provided by IF filter 208 is typically a band of channels but may be even a single channel.

The output of first IF filter 208 is split at 209 and provided to separate mixers 210 and 212. Mixer 210 mixes the IF1 signal with a signal from local oscillator 214 to produce a low IF ‘Q’ signal. Mixer 212, meanwhile, produces a low IF ‘I’ signal by mixing the IF1 signal with the signal from local oscillator 214 after being phase shifted ninety degrees via phase shifter 216. The low IF ‘I’ and ‘Q’ signals are supplied to polyphase image rejection filter 218, which outputs a complex combination of the ‘I’ and ‘Q’ signals and attenuates any image frequencies.

The low IF I and Q frequencies that are used permit integration of polyphase image rejection filter 218 on tuner IC 201 along with the rest of the components of tuner 200. Hence, the need for an additional external IF filter, such as filter 116 of tuner 100, is eliminated. The output of image rejection filter 218 is subjected to further processing and/or filtering in a known manner, including processing by a high performance analog-to-digital converter 220, to provide high quality digital and analog television reception.

It is critical to the present invention that mixers 210 and 212 down-convert the ‘I’ and ‘Q’ signals to a low IF, preferably in the range of about ½ to ⅓ of the second IF frequency that is typically present in a traditional tuner, and most preferably in the range of 10-15 MHz. In one implementation, a second IF frequency of 11 MHz is employed. In this lower frequency range, a lower degree of selectivity is required (due to the relatively smaller bandwidth) and is it possible to produce an integrated image rejection filter capable of supplying the required interfering channel rejection.

FIG. 3 depicts a second embodiment of the present invention, usable for digital signal reception. Tuner 300 is also advantageous in that all components, with the exception of one external IF filter, may be integrated on-chip. It includes first frequency conversion stage 302, comprising mixer 304 and local oscillator 306, which mixes the received signal with a signal from local oscillator 306 to generate a signal at a higher first intermediate frequency (IF1). Signal IF1 is coupled to first IF filter 308, which is implemented off-chip and provides coarse channel selection. Again, the relatively high IF1 frequency precludes integration of filter 308.

The output of first IF filter 308 is split at 309 and provided to separate mixers 310 and 312. Mixer 310 mixes the IF1 signal with a signal from local oscillator 314 to produce a low IF ‘Q’ signal. Mixer 312, meanwhile, produces a low IF ‘I’ signal by mixing the IF1 signal with the signal from local oscillator 314 after being phase shifted by ninety degrees by passing through ninety degrees phase shifter 316. The ‘I’ and ‘Q’ signals are down-converted to a low IF, preferably in the range of about ½ to ⅓ of the second IF frequency present in a traditional tuner, and most preferably in the range of 10-15 MHz. In one implementation, the second IF frequency is 11 MHz. To this point, tuner 300 is identical and functions in the same fashion as tuner 200.

Where the tuner is intended for digital signal reception only, image rejection filter 218 may be replaced by integrated DC notch filters 318 and 320. The low IF ‘I’ signal is passed through DC notch filter 318, and the low IF ‘Q’ signal is passed through DC notch filter 320. The notch filters isolate a very narrow slice of the received signal in the frequency band of interest. Tuner 300, while suitable for processing digital television signals, is not suitable for processing analog television signals since the formation of a “notch” at the center frequency will distort the analog video. In an alternate implementation, low pass filters with AC coupling, rather than notch filters, are utilized.

Because of the relatively low second IF frequency, a lower degree of selectivity is required and notch filters 318 and 320 may be integrated on tuner IC 301 along with the rest of the components of tuner 300. Hence, the need for an additional external IF filter, such as filter 116 of tuner 100, is eliminated. The outputs of notch filters 318 and 320 are subjected to further processing and/or filtering in a known manner, including processing by high performance analog-to-digital converters 322 and 324, to provide high quality digital and analog television reception.

It should be noted that only those components necessary for an understanding of inventive tuners 200 and 300 have been illustrated in FIGS. 2 and 3. Tuners 200 and 300 will include additional components that are not relevant to the present invention but are well known to those of ordinary skill in the art. For instance, a low noise amplifier may precede the first frequency conversion stage in order to amplify the received RF signal a fixed amount with minimal noise amplification. An RF attenuator may also be employed to set signal gain based on the strength of the received signal. An IF AGC amplifier may be included to further control the overall tuner gain. These and other components of television tuners are well known to those of ordinary skill in the art and further explanation and/or illustration is not necessary for an understanding of the present invention.

FIG. 4 illustrates a method 400 for tuning a television signal according to the present invention. In step 402, a broadcast television signal is received. The broadcast television signal may have analog or digital modulation. In step 404, the television signal is up-converted to a frequency IF1. In step 406, off-chip filtering is performed. In one embodiment, step 406 is performed using an IF SAW filter that is external to the tuner IC. In steps 408 and 410, the television signal is split into its I and Q components and down-converted to a low IF. In one embodiment, the low IF is in the approximate range of 10-15 MHz. Finally, in step 412, on-chip filtering is performed. In a tuner intended to support both analog and digital modulation, the on-chip filtering is performed using an image rejection filter that is integrated on the tuner IC. In a tuner intended to support digital modulation only, the on-chip filtering may be performed using DC notch filters that are integrated on the tuner IC.

While various embodiments of the invention have been described, it will be apparent to those of ordinary skill in the art that many more embodiments and implementations are possible that are within the scope of this invention.

1. A television tuner comprising:
a tuner IC comprising:
a first frequency conversion stage that up-converts the frequency of a received television signal to a higher frequency;
an output from the up-converter to the input of an off-chip filter;
an input from the output of the off-chip filter;
a second frequency conversion stage that accepts the output of the off-chip filter, separates the television signal into I and Q components and down-converts the I and Q components to a low IF frequency; and
an integrated, on-chip filter for fine-tuning the down-converted low IF I and Q components; and
the off-chip filter, wherein the off-chip filter is external to the tuner IC and provides coarse tuning of the up-converted television signal.

2. A tuner as claimed in claim 1, wherein the off-chip filter is an IF SAW filter.

3. A tuner as claimed in claim 1, wherein the first frequency conversion stage comprises a mixer and a local oscillator.

4. A tuner as claimed in claim 1, wherein the second frequency conversion stage comprises a local oscillator, a first mixer that mixes a signal from the local oscillator with the up-converted television signal to produce the low IF Q component; and a second mixer that mixes a phase-shifted version of the local oscillator signal with the up-converted television signal to produce the low IF I component.

5. A tuner as claimed in claim 4, wherein the low IF I and Q components have a frequency in a range of approximately 10-15 MHz.

6. A tuner as claimed in claim 1, wherein the on-chip filter is an image rejection filter.

7. A tuner as claimed in claim 6, wherein the received television signal is an analog or digital signal.

8. A tuner as claimed in claim 1, wherein the on-chip filter is a DC notch filter.

9. A tuner as claimed in claim 8, wherein the received television signal is a digital signal.

10. A set top box comprising a tuner as claimed in claim 1.

11. A terrestrial television receiver comprising a tuner as claimed in claim 1.

12. A cable modem comprising a tuner as claimed in claim 1.

13. A tuner IC comprising:
a first frequency conversion stage that up-converts the frequency of a received television signal to a frequency IF1;
an output from the first frequency conversion stage for off-chip filtering;
an input to receive an off-chip filtered television signal;
a second frequency conversion stage that accepts the off-chip filtered television signal, separates the signal into I and Q components and down-converts the I and Q components to a low IF frequency; and
an integrated, on-chip filter for fine-tuning the down-converted low IF I and Q components.

14. A tuner IC as claimed in claim 13, wherein the second frequency conversion stage comprises a local oscillator, a first mixer that mixes a signal from the local oscillator with the up-converted television signal to produce the low IF Q component; and a second mixer that mixes a phase-shifted version of the local oscillator signal with the up-converted television signal to produce the low IF I component.

15. A tuner as claimed in claim 14, wherein the low IF I and Q components have a frequency in a range of approximately 10-15 MHz.

16. A tuner as claimed in claim 13, wherein the on-chip filter is an image rejection filter.

17. A tuner as claimed in claim 16, wherein the received television signal is an analog or digital signal.

18. A tuner as claimed in claim 13, wherein the on-chip filter is a DC notch filter.

19. A tuner as claimed in claim 18, wherein the received television signal is a digital signal.

20. A television tuner comprising:
integrated up-conversion means for up-converting the frequency of a received television signal;
non-integrated filtering means for coarse tuning the received television signal;
integrated down-conversion means for down-converting the up-converted signal into low IF I and Q components; and
integrated filtering means for fine tuning the low IF I and Q components.

21. A tuner as claimed in claim 20, wherein the integrated filtering means comprise an image rejection filter.

22. A tuner as claimed in claim 20, wherein the integrated filtering means comprise a DC notch filter.

23. A tuner as claimed in claim 20, wherein the low IF I and Q components have a frequency in a range of approximately 10-15 MHz.

24. A method for tuning a television signal comprising:
receiving a television signal;
up-converting the signal to a higher frequency;
performing off-chip filtering on the higher frequency signal;
down-converting the higher frequency signal into low IF I and Q components; and
performing on-chip filtering on the down-converted I and Q components.
